(19) United States
(12) Patent Application Publication
(10) Pub. No.: US 2009/0040163 A1
(43) Pub. Date: Feb. 12, 2009

(54) PROGRAMMABLE NONVOLATILE MEMORY EMBEDDED IN A GAMMA VOLTAGE SETTING IC FOR STORING LOOKUP TABLES

(76) Inventor: Wein-Town Sun, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/046,445

(22) Filed: Mar. 11, 2008

Related U.S. Application Data
(60) Provisional application No. 60/954,024, filed on Aug. 6, 2007.

(51) Int. Cl. G09G 3/36

(52) U.S. Cl. 345/98

(57) ABSTRACT

A gamma voltage setting IC in an LCD with an OTP memory—a one time programmable nonvolatile memory or an MTP or flash memory—a multiple time programmable nonvolatile memory embedded in for storing lookup tables of the voltages of gamma curves and the common voltage values is capable of outputting a corresponding voltage mode according to the sensed result of a temperature sensor or an ambient luminance sensor. The logic process of the OTP memory and the logic process of the gamma voltage setting IC are completely compatible, and the logic process of the MTP or flash memory only needs two or three photomask processes more than the logic process of the gamma voltage setting IC.

### CROSS REFERENCE TO RELATED APPLICATIONS

This application claims the benefit of U.S. Provisional Application No. 60/954,024, filed on Aug. 6, 2007 and entitled “Neobit Application to Tcon of LCD Displays”, the contents of which are incorporated herein by reference.

### BACKGROUND OF THE INVENTION

1. Field of the Invention

The present invention relates to a gamma voltage setting IC in an LCD for offering a voltage of a gamma curve and a common voltage, especially to a gamma voltage setting IC in which a programmable nonvolatile memory is embedded for storing lookup tables.

2. Description of the Prior Art

Ideally, when displaying a grayscale image on the screen, the grayscale on the screen is supposed to increase or decrease gradually; but in reality, the display result is often not so desirable. The common method used to correct this phenomenon in LCD TV field is applying the gamma correction. The gamma correction is a nonlinear operation used to make an inverse from the nonlinear curve caused by deviated grayscale of an image shown on a screen in a video system. The Gamma correction is not only used for calibrating the gray level of an image but also the gray level of RGB color of the image, that means gamma curve can be used for dynamic adjustment according to the content of an image.

Different gamma curves remedy different deviating results caused by varied causes such as temperature, specific electrical characteristics of each pixel electrode, ambient luminance, backlight, and the image content etc. For example, if the ambient luminance gets brighter, the luminance of the image should increase correspondingly to avoid a relatively dark frame; if the ambient luminance gets dimmer, the luminance of the image should decrease correspondingly to avoid a relatively bleached-out frame. If the color temperature decreases, the more yellowish an image becomes; and at a higher color temperature, the image will look more bluish. Moreover, if the backlight differs from each image or the backlight is adjusted dimmer for power saving cause, different gamma curves should be given correspondingly to get a better contrast ratio of the maximum luminance in a frame to the minimum luminance in the frame. The lower gray level of an image, the more bluish the image. But according to the related art, no matter what temperature it is, or how dark the ambient luminance becomes, the corresponding gamma curve is always the same, and the gamma curve setting is stored in an external EEPROM. This design makes a worse image quality, and a more complicated PCB design.

Please refer to FIG. 1. FIG. 1 is the schematic drawing of a pixel 201 according to the prior art. The pixel 201 includes a liquid crystal capacitor 10, a storage capacitor 12, a gate line 16, a data line 18, a source driver 28, a gate driver 30, and a transistor 20. The data line 18 couples to a source driver 28, and the gate line 16 couples to a gate driver 30. The transistor 20 has a gate electrode 24 coupled to the gate line 16, a drain electrode 26 coupled to the first end of the crystal liquid capacitor 10, and a source electrode 22 coupled to the data line 18. The first end of the storage capacitor 12 is coupled to the drain electrode 26 of the transistor 20. The second end of the crystal liquid capacitor 10 is coupled to the second end of the storage capacitor 12, and the joint point is called the common electrode, which is supplied by the common voltage “Vcom”. The data line 18 transmits image data of a pixel to the source electrode 22 with “Vd” voltage, and the gate line 16 passes a “Vg” voltage to the gate electrode 24 to switch on the transistor 20 to transfer the data into the storage capacitor 12. The gray level of a pixel is shown through the twisted angle of the crystal liquid capacitor 10 determined by the voltage difference between the two ends of it. The “Vcom” voltage is a reference voltage for a positive frame and a negative frame; if the voltage applied on the first end of the crystal liquid capacitor 10 is greater than the “Vcom” voltage, then the frame is a positive frame; if the voltage applied on the first end of the crystal liquid capacitor 10 is less than the “Vcom” voltage, then the frame is a negative frame.

As soon as the gate line 16 passes the “Vg” voltage to the gate electrode 24 to switch on the transistor 20, the inputted voltage changes drastically with a 30V˜40V amplitude of vibration. A parasitic capacitor Cgd is generated between the gate electrode 24 and the drain electrode 26 of the transistor 20, and plays an impact on the voltage of the first end of the crystal liquid capacitor 10 with a so-called “feed-through” voltage. But after the transistor 20 is switched on, the source driver 28 begins to charge the transistor 20 through a current “Id”; although the initial voltage at the first end of the crystal liquid capacitor 10 is affected by the “feed-through” voltage, the source diver still can charge the crystal liquid capacitor 10 to a default voltage value correctly. The time interval from the transistor 20 switched on to the crystal liquid capacitor 10 charged to the correct voltage value is very short, hence people can hardly tell the diversity it brings. Similarly, the drastic voltage amplitude of vibration occurs at a moment when the gate line 16 shuts off. However, at this time because the source driver 28 no longer charges the crystal liquid capacitor 10, the “feed-through” voltage keeps a voltage drop at the first end of the crystal liquid capacitor 10 which affects the gray level showed by the crystal liquid capacitor 10. This voltage drop (or the incorrect gray level) will remain till the next time spot that the gate line 16 passes another “Vg” voltage to the gate electrode 24 to switch on the transistor 20 again. In other words, the appearance of the image with incorrect gray level remains long enough for a viewer to sense. In order to offset this “feed-through” voltage, the “Vcom” voltage has to be diminished to the same value to recover the true gray level of the pixel.

As the ambient temperature goes up, the electric leakages of the transistor 20 and the two capacitors 10 and 12 become severe, therefore the “Vcom” will shift and needed to be remedied again correspondingly; otherwise the shifted “Vcom” voltage will bring a less voltage difference in a positive frame and relatively, a greater voltage difference in a negative frame, or vice versa. Once the voltage difference between the positive frame and the negative frame of the same gray level differs, and moreover, the frame constantly switches between the positive polarity and the negative polarity, flickers are sensed by a viewer. Please refer to FIG. 2. FIG. 2 is the drawing of a shifted common voltage in a positive frame and a negative frame.

To sum up, the common voltage “Vcom” of a gamma voltage setting IC needs several modifications according to different circumstances, but according to the related art, no matter what temperature the ambient circumstance is, the corresponding common voltage is always the same and the corresponding common voltage setting is stored in an external EEPROM. This design makes a worse image quality, and a more complicated PCB design.

### SUMMARY OF THE INVENTION

The present invention relates to a gamma voltage setting IC comprising an integrated circuit, a memory module, a digital variable voltage generator, and a common voltage buffer. The memory module embedded in the integrated circuit comprises a programmable nonvolatile memory for storing lookup tables and registers for selecting a voltage value from the lookup tables in the programmable nonvolatile memory according to an inputted digital signal. The digital variable voltage generator is for generating a common voltage according to the voltage value selected by the registers, and the common voltage buffer coupled to the digital variable voltage generator is for outputting the common voltage generated by the digital variable voltage generator.

The present invention relates to a gamma voltage setting IC comprising an integrated circuit, a programmable nonvolatile memory, a multiplexer, a selecting circuitry, a digital variable voltage generator, and a voltage output unit. The programmable nonvolatile memory is embedded in the integrated circuit for storing lookup tables. The multiplexer is for receiving a control signal. The selecting circuitry is for selecting voltage values of a corresponding gamma curve stored in the lookup tables in the programmable nonvolatile memory according to the control signal. The digital variable voltage generator is for generating voltages according to the voltage values selected by the selecting circuitry, and the voltage output unit coupled to the digital variable voltage generator is for outputting the voltages generated by the digital variable voltage generator.

The present invention also relates to a gamma voltage setting IC comprising an integrated circuit, a memory module, a multiplexer, a selecting circuitry, a digital variable voltage generator, a common voltage buffer, and a voltage output unit. The memory module embedded in the integrated circuit comprises a programmable nonvolatile memory for storing lookup tables and registers for selecting a voltage value from the lookup tables in the programmable nonvolatile memory. The multiplexer is for receiving a control signal. The selecting circuitry is for selecting voltage values of a corresponding gamma curve stored in the lookup tables in the programmable nonvolatile memory according to the control signal. The digital variable voltage generator is for generating voltages according to the voltage values selected by the selecting circuitry or generating a common voltage according to the voltage value selected by the registers. The common voltage buffer coupled to the digital variable voltage generator is for outputting the common voltage generated by the digital variable voltage generator, and the voltage output unit coupled to the digital variable voltage generator is for outputting the voltages generated by the digital variable voltage generator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a pixel according to the prior art.

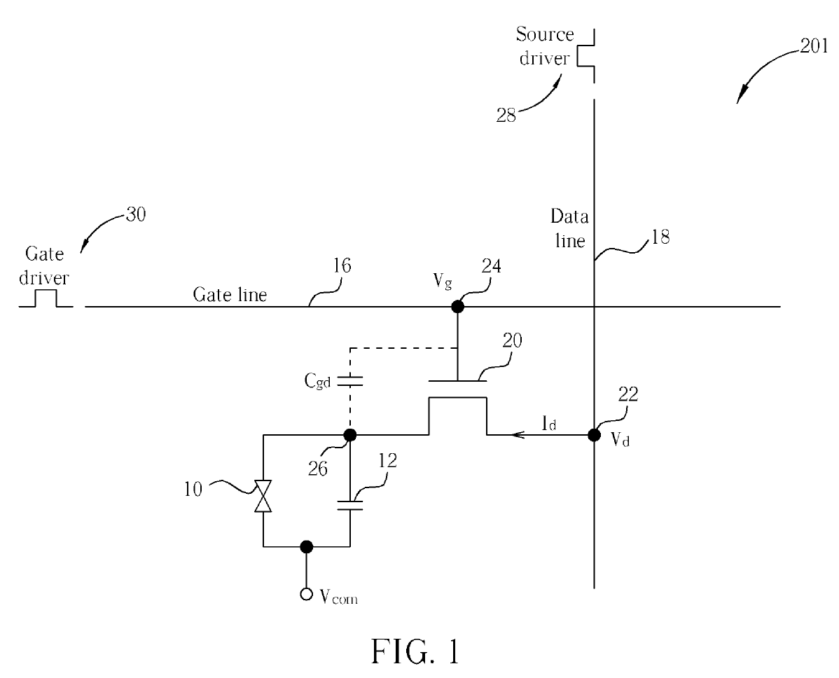

FIG. 2 is a drawing of a shifted common voltage in a positive frame and a negative frame according to the prior art.

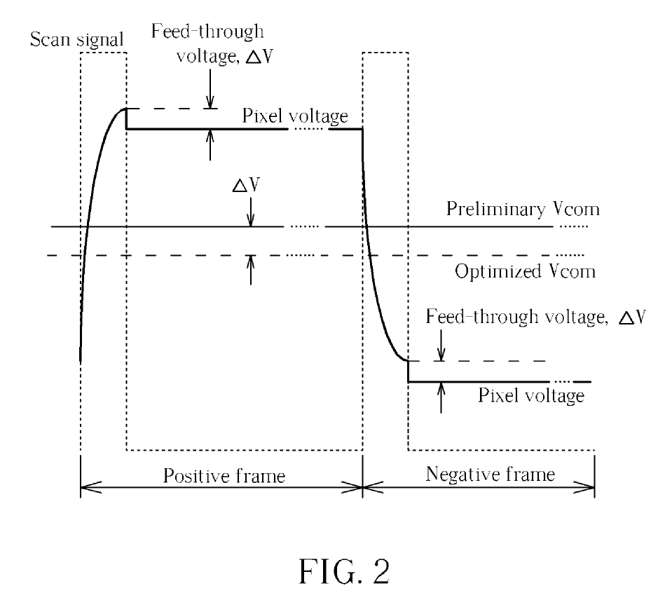

FIG. 3 is a block diagram of generating a voltage of a gamma curve in a gamma voltage setting IC according to the first embodiment of the present invention.

FIG. 4 is a drawing of the relationship between output voltages and temperatures of a temperature sensor according to the second embodiment of the present invention.

FIG. 5 is a block diagram of generating a common voltage in a gamma voltage setting IC according to the second embodiment of the present invention.

FIG. 6 is a block diagram of generating voltages of a corresponding gamma curve and a common voltage in a gamma voltage setting IC according to the third embodiment of the present invention.

### DETAILED DESCRIPTION

The present invention combines a gamma voltage setting IC with an embedded memory—one time programmable nonvolatile memory (OTP) or multiple time programmable nonvolatile memory (MTP) or flash memory for storing lookup tables of common voltages and gamma curves.

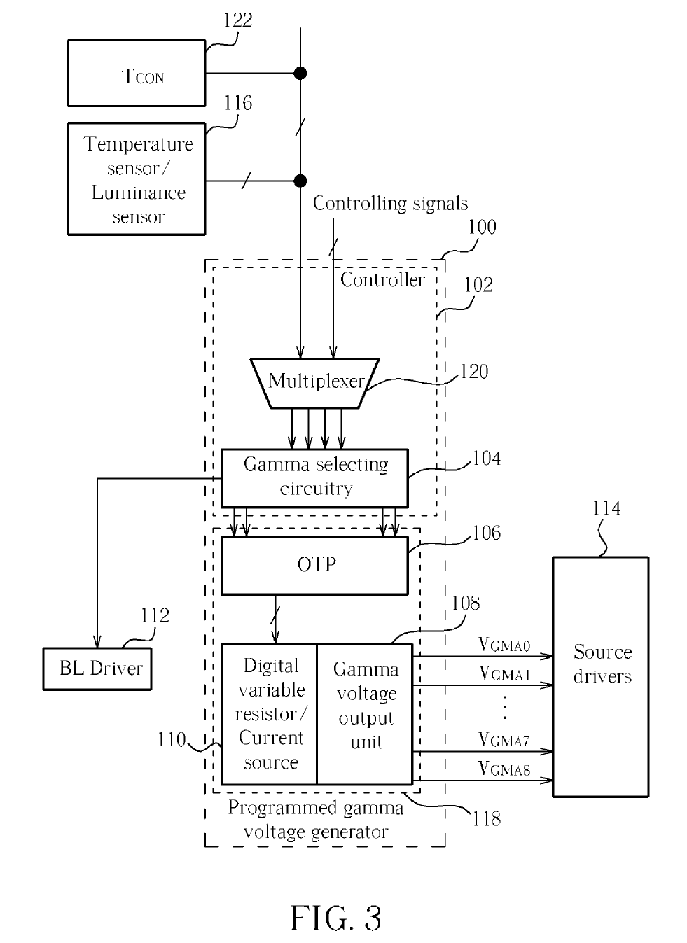

Please refer to FIG. 3. FIG. 3 is a block diagram of generating voltages of a corresponding gamma curve in a gamma voltage setting IC 100 according to the first embodiment of the present invention. The gamma voltage setting IC 100 includes a controller 102, a programmed gamma voltage generator 118, a multiplexer 120, a gamma selecting circuitry 104, an OTP memory 106, a gamma voltage output unit 108, and a digital variable resistor 110. The controller 102 receives a digital controlling signal (an address) transmitted by an external temperature sensor 116 (or an external luminance sensor) or a timing controller (Tcon) 122 from the multiplexer 120, and then transmits the address to the gamma selecting circuitry 104 for selecting corresponding voltage values of a gamma curve from a lookup table stored in the OTP memory 106 for access. Then the selected voltage values are sent to the digital variable resistor 110 to generate voltages and to the backlight control unit 112 for performing a dynamic contrast function. The digital variable resistor 110 is implemented by a resistor string with a plurality of serially arranged resistors capable of offering different reference voltages of a gamma curve to adjust the liquid crystal to the required color or gray level. Subsequently, the generated voltages by the digital variable resistor 110 are sent to the gamma voltage output unit 108 to output to the external source drivers 114 as reference voltages.

Storing gamma curves in the internal OTP memory in a gamma voltage setting IC, the user only needs to input a simple digital address and can adequately correct the deviations caused by the video content, ambient light, backlight, and temperature etc. To sum up, the first embodiment of the present invention integrates an controller chip and a programmed voltage generator chip into a gamma voltage setting IC with no additional logic process added for an embedded one time programmable nonvolatile memory, or with two or three additional photomask processes for an embedded multiple time programmable nonvolatile memory. The integration can decrease the size of a system board, enhance data-transmitting speed, improve the quality of the images, and reduce the complexity of the PCB design.

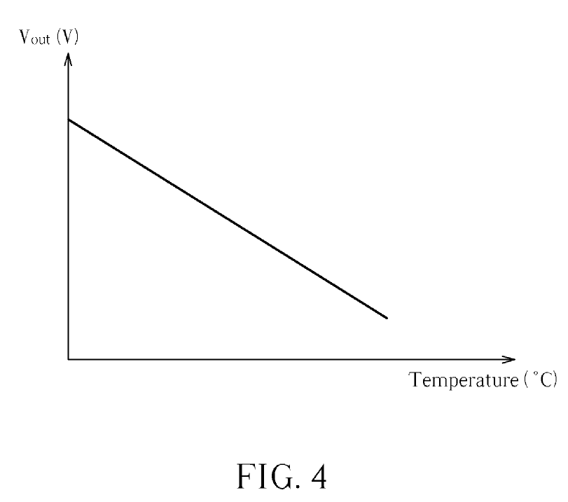

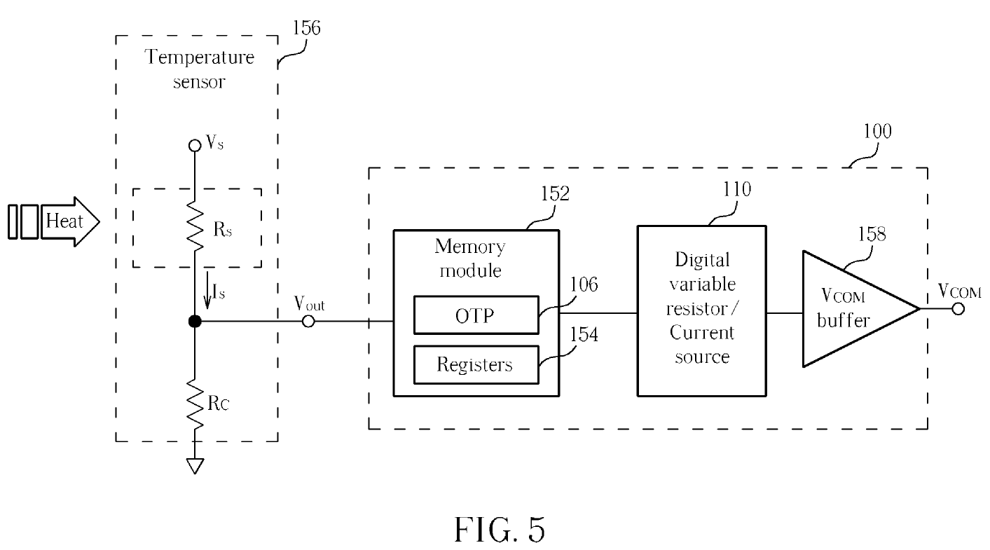

The second embodiment of the present invention utilizes a temperature sensor to sense ambient heat, and according to the sensing result, a “Vcom” voltage is altered to escape uncomfortable flickers in frames. Please refer to FIG. 4. FIG. 4 is the drawing of the relationship between output voltages and temperatures of a temperature sensor according to the second embodiment of the present invention. Please refer to FIG. 5. FIG. 5 is a block diagram of generating a common voltage in the gamma voltage setting IC 100 according to the second embodiment of the present invention. The gamma voltage setting IC 100 includes a memory module 152, the OTP memory 106, registers 154, a common voltage output buffer 158, and a digital variable resistor 110. The memory module 152 receives an inputted digital signal from an external temperature sensor 156, and then selects a corresponding voltage value from the OTP memory 106 by the internal registers 154 according to the digital inputted signal, then sends the selected voltage value to the digital variable resistor 110. The corresponding common voltage values form lookup tables stored in the OTP memory 106 for access, and the digital variable resistor 110 is implemented by a resistor string with a plurality of serially arranged resistors capable of outputting different reference voltages. At last, the corresponding common voltage is generated by the digital variable resistor 110 and sent to the common voltage output buffer 158 for outputting.

Storing common voltages in the internal OTP memory in a gamma voltage setting IC, the user can adequately correct the deviations caused by temperature. The second embodiment of the present invention integrates the common voltage adjustment function into a gamma voltage setting IC with no additional logic process added for an embedded one time programmable nonvolatile memory, or with two or three additional photomask processes for an embedded multiple time programmable nonvolatile memory. The integration can decrease the size of a system board, enhance data-transmitting speed, improve the quality of the images, and reduce the complexity of the PCB design.

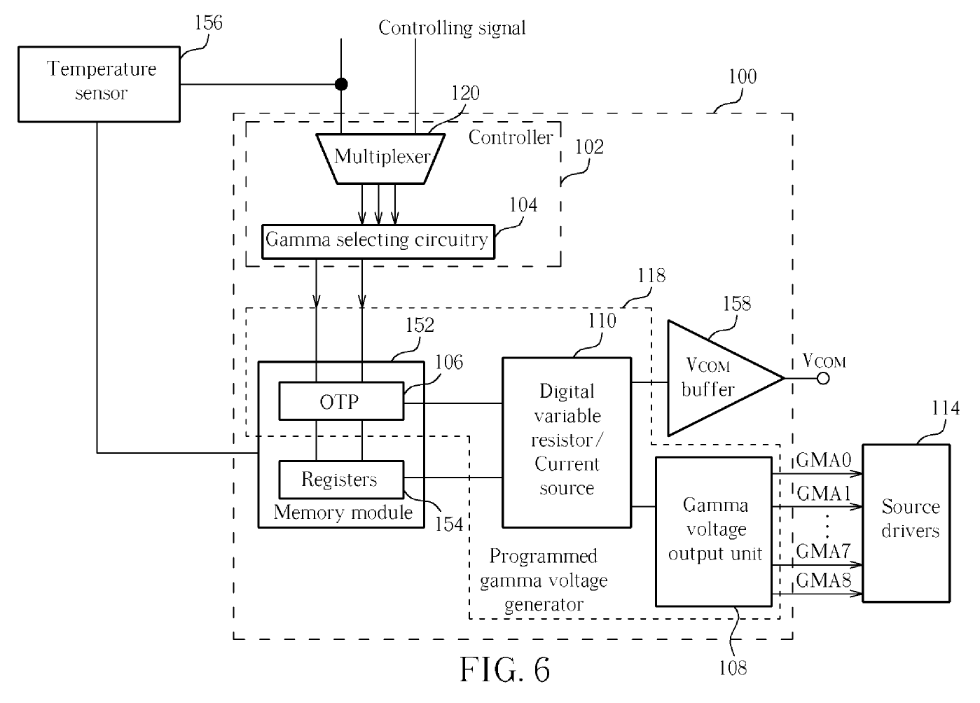

Please refer to FIG. 6. FIG. 6 is a block diagram of generating voltages of a corresponding gamma curve and a common voltage in the gamma voltage setting IC 100 according to the third embodiment of the present invention. The gamma voltage setting IC 100 includes the controller 102, the programmed gamma voltage generator 118, the multiplexer 120, the gamma selecting circuitry 104, the memory module 152, the OTP memory 106, the registers 154, the common voltage output buffer 158, the gamma voltage output unit 108, and the digital variable resistor 110. The controller 102 receives a digital controlling signal (an address) transmitted by an external temperature sensor 156 or a timing controller (Tcon) 122 from the multiplexer 120, and then transmits the address to the gamma selecting circuitry 104 for selecting corresponding voltage values of a gamma curve from a lookup table stored in the OTP memory 106 for access. Then the selected voltage values are sent to the digital variable resistor 110 to generate voltages and to the backlight control unit 112 for performing a dynamic contrast function. The memory module 152 receives an inputted digital signal from an external temperature sensor 116, and then selects a corresponding voltage value from the OTP memory 106 by the internal registers 154 according to the digital inputted signal, then sends the selected voltage value to the digital variable resistor 110. The corresponding common voltage values form lookup tables stored in the OTP memory 106 for access. The digital variable resistor 110 is implemented by a resistor string with a plurality of serially arranged resistors capable of offering different reference voltages of a gamma curve to adjust the liquid crystal to the required color or gray level, or offering a common voltage. The registers 154 of the memory module 152 switch the digital variable resistor 110 to generate a common voltage or voltages of a gamma curve. At last, the generated voltages of a gamma curve by the digital variable resistor 110 are sent to the gamma voltage output unit 108 to output to the external source drivers 114 as reference voltages, and the corresponding common voltage is generated by the digital variable resistor 110 and sent to the common voltage output buffer 158 for outputting.

In above embodiments, the OTP memory is replaceable by the MTP or flash memory to meet multi-time programmable need of the user, and moreover, the digital variable resistor in the gamma voltage setting IC is replaceable by a digital variable current source as well.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A gamma voltage setting IC comprising:
an integrated circuit;
a memory module embedded in the integrated circuit comprising a programmable nonvolatile memory for storing lookup tables and registers for selecting a voltage value from the lookup tables in the programmable nonvolatile memory according to an inputted digital signal;
a digital variable voltage generator for generating a common voltage according to the voltage value selected by the registers; and
a common voltage buffer coupled to the digital variable voltage generator for outputting the common voltage generated by the digital variable voltage generator.

2. The gamma voltage setting IC of claim 1 wherein the programmable nonvolatile memory is a one time programmable nonvolatile memory.

3. The gamma voltage setting IC of claim 2 wherein a logic process of the one time programmable nonvolatile memory is compatible to a logic process of the integrated circuit.

4. The gamma voltage setting IC of claim 1 wherein the programmable nonvolatile memory is a multiple time programmable nonvolatile memory.

5. The gamma voltage setting IC of claim 4 wherein a logic process of the multiple time programmable nonvolatile memory needs no more than 3 photomask processes than a logic process of the integrated circuit.

6. The gamma voltage setting IC of claim 1 wherein the lookup tables comprise common voltage lookup tables.

7. The gamma voltage setting IC of claim 1 wherein the digital variable voltage generator is a digital variable current source.

8. The gamma voltage setting IC of claim 1 wherein the digital variable voltage generator is a digital variable resistor.

9. A gamma voltage setting IC comprising:
an integrated circuit;
a programmable nonvolatile memory embedded in the integrated circuit for storing lookup tables;
a multiplexer for receiving a control signal;
a selecting circuitry for selecting voltage values of a corresponding gamma curve stored in the lookup tables in the programmable nonvolatile memory according to the control signal;
a digital variable voltage generator for generating voltages according to the voltage values selected by the selecting circuitry; and
a voltage output unit coupled to the digital variable voltage generator for outputting the voltages generated by the digital variable voltage generator.

10. The gamma voltage setting IC of claim 9 wherein the programmable nonvolatile memory is a one time programmable nonvolatile memory.

11. The gamma voltage setting IC of claim 10 wherein a logic process of the one time programmable nonvolatile memory is compatible to a logic process of the integrated circuit.

12. The gamma voltage setting IC of claim 9 wherein the programmable nonvolatile memory is a multiple time programmable nonvolatile memory.

13. The gamma voltage setting IC of claim 12 wherein a logic process of the multiple time programmable nonvolatile memory needs no more than 3 photomask processes than a logic process of the integrated circuit.

14. The gamma voltage setting IC of claim 9 wherein the lookup tables comprise gamma curve lookup tables.

15. The gamma voltage setting IC of claim 9 wherein the digital variable voltage generator is a digital variable current source.

16. The gamma voltage setting IC of claim 9 wherein the digital variable voltage generator is a digital variable resistor.

17. A gamma voltage setting IC comprising:
an integrated circuit;
a memory module embedded in the integrated circuit comprising a programmable nonvolatile memory for storing lookup tables and registers for selecting a voltage value from the lookup tables in the programmable nonvolatile memory;
a multiplexer for receiving a control signal;
a selecting circuitry for selecting voltage values of a corresponding gamma curve stored in the lookup tables in the programmable nonvolatile memory according to the control signal;
a digital variable voltage generator for generating voltages according to the voltage values selected by the selecting circuitry or generating a common voltage according to the voltage value selected by the registers;
a common voltage buffer coupled to the digital variable voltage generator for outputting the common voltage generated by the digital variable voltage generator; and
a voltage output unit coupled to the digital variable voltage generator for outputting the voltages generated by the digital variable voltage generator.

18. The gamma voltage setting IC of claim 17 wherein the programmable nonvolatile memory is a one time programmable nonvolatile memory.

19. The gamma voltage setting IC of claim 18 wherein a logic process of the one time programmable nonvolatile memory is compatible to a logic process of the integrated circuit.

20. The gamma voltage setting IC of claim 17 wherein the programmable nonvolatile memory is a multiple time programmable nonvolatile memory.

21. The gamma voltage setting IC of claim 20 wherein a logic process of the multiple time programmable nonvolatile memory needs no more than 3 photomask processes than a logic process of the integrated circuit.

22. The gamma voltage setting IC of claim 17 wherein the lookup tables comprise common voltage lookup tables and gamma curve lookup tables.

23. The gamma voltage setting IC of claim 17 wherein the digital variable voltage generator is a digital variable current source.

24. The gamma voltage setting IC of claim 17 wherein the digital variable voltage generator is a digital variable resistor.
